(19) United States
(12) Patent Application Publication
(10) Pub. No.: US 2010/0253886 A1
(43) Pub. Date: Oct. 7, 2010

(54) POLARIZING FILM INCLUDING ANTISTATIC COATING LAYER

(76) Inventors: Jee Woung KIM, (US); Sung Chul Hwang, (US); Kyoung Ku Kang, (US)

Correspondence Address: LEE & MORSE, P.C., 3141 FAIRVIEW PARK DRIVE, SUITE 500, FALLS CHURCH, VA, 22042, US

(21) Appl. No.: 12/824,530

(22) Filed: Jun. 28, 2010

Related U.S. Application Data
(63) Continuation of application No. PCT/KR2008/007477, filed on Dec. 17, 2008.

(30) Foreign Application Priority Data
Dec. 28, 2007 (KR) 10-2007-0139591

(51) Int. Cl. G02F 1/1335; G02B 5/30

(52) U.S. Cl. 349/96; 359/485

(57) ABSTRACT

A polarizing film, including a polarizer, a resin film as a base film, and an antistatic coating layer, the antistatic coating layer containing a cured mixture of a conductive polymer, a curable resin, a hydroxyacrylate compound, a cellulose compound, and a photopolymerization initiator.

### CROSS-REFERENCE TO RELATED APPLICATION

This application is a continuation of pending International Application No. PCT/KR2008/007477, entitled “Polarizing Film Comprising Antistatic Coating Layer,” which was filed on Dec. 17, 2008, the entire contents of which are hereby incorporated by reference for all purposes.

### BACKGROUND

1. Field

Embodiments relate to a polarizing film including an antistatic coating layer.

2. Description of the Related Art

A general polarizing film may include a film-like polarizer, which may be composed of polyvinyl alcohol and cellulose resin films bonded to both surfaces of the polarizer. The general polarizing film typically has a multilayer structure, in which a protective film is adhered to one of the resin films to protect the surface of the resin film from damage during transport, and a pressure-sensitive adhesive layer and a release film are sequentially laminated on the other resin film. Such a polarizing film is used as an important component of liquid crystal display (LCDs).

### SUMMARY

It is a feature of an embodiment to provide a polarizing film having an antistatic coating layer, the antistatic coating layer of the polarizing film having good adhesion to both a triacetyl cellulose base film and a pressure-sensitive adhesive (PSA) layer.

It is another feature of an embodiment to provide a polarizing film that exhibits desirable characteristics with respect to one or more of transparency, surface resistance, and moisture resistance.

It is another feature of an embodiment to provide a polarizing film suitable for use in LCDs for large-screen TVs.

At least one of the above and other features and advantages may be realized by providing a polarizing film, including a polarizer, a resin film as a base film, and an antistatic coating layer, the antistatic coating layer containing a cured mixture of a conductive polymer, a curable resin, a hydroxyacrylate compound, a cellulose compound, and a photopolymerization initiator.

The antistatic coating layer may be formed by curing a composition that contains 0.001 to 20% by weight of the conductive polymer, 1 to 80% by weight of the curable resin, 1 to 60% by weight of the hydroxyacrylate compound, 0.1 to 40% by weight of the cellulose compound, and 0.1 to 20% by weight of the photopolymerization initiator.

The conductive polymer may be polyethylene dioxythiophene (PEDOT) doped with polystyrenesulfonate (PSS).

The hydroxyacrylate compound may include one or more of an oligomer and a monomer.

The hydroxyacrylate compound may include at least one oligomer, the at least one oligomer including one or more of 2-hydroxyethyl acrylate oligomer, 2-hydroxypropyl acrylate oligomer, and pentaerythritol triacrylate oligomer.

The hydroxyacrylate compound may include at least one monomer, the at least one monomer including one or more of 2-hydroxyethyl methacrylate, hydroxyethyl methacrylate, 2-hydroxypropyl methacrylate, 2-hydroxyethyl acrylate, 2-hydroxypropyl acrylate, Cardura acrylate, Cardura methacrylate, caprolactone acrylate, caprolactone methacrylate, 2,3-dihydroxypropyl acrylate, 2,3-dihydroxypropyl methacrylate, 4-hydroxymethylcyclohexyl methyl acrylate, and 4-hydroxymethylcyclohexyl methyl methacrylate.

The cellulose compound may be cellulose acetate butyrate (CAB), cellulose acetate propionate (CAP), or a mixture thereof.

The photopolymerization initiator may include one or more of an acetophenone, a benzophenone, Michler's benzoylbenzoate, α-amyloxime ester, a thioxanthone, or a mixture thereof.

The antistatic coating layer may be formed on a first surface of the resin film opposite to a second surface to which the polarizer is bonded, the second surface being a surface of the resin film to which a pressure-sensitive adhesive is applied.

The antistatic coating layer may have a thickness of about 50 nm to about 400 nm.

The polarizing film may further include an acrylic pressure-sensitive adhesive layer. The acrylic pressure-sensitive adhesive layer may contact the antistatic coating layer, the antistatic coating layer may contact the resin film, the resin film being a triacetyl cellulose film, and the cellulose compound may be cellulose acetate butyrate (CAB), cellulose acetate propionate (CAP), or a mixture thereof.

At least one of the above and other features and advantages may also be realized by providing a liquid crystal display, including a liquid crystal panel, and a polarizing film, the polarizing film including an acrylate pressure-sensitive adhesive layer attaching the polarizing film to the liquid crystal panel, the polarizing film further including a polarizer; a resin film as a base film, and an antistatic coating layer contacting the acrylate pressure-sensitive adhesive layer and the resin film, the antistatic coating layer containing a cured mixture of a conductive polymer, a curable resin, a hydroxyacrylate compound, a cellulose compound, and a photopolymerization initiator.

### BRIEF DESCRIPTION OF THE DRAWINGS

The above and other features and advantages will become more apparent to those of ordinary skill in the art by describing in detail example embodiments with reference to the attached drawings, in which:

FIG. 1 illustrates a schematic cross-sectional view of a polarizing film according to an embodiment; and

FIG. 2 illustrates a schematic cross-sectional view of a liquid crystal display including polarizing film according to an embodiment.

### DETAILED DESCRIPTION

Korean Patent Application No. 10-2007-0139591, filed on Dec. 28, 2007, in the Korean Intellectual Property Office, and entitled: “Polarizing Film Comprising Antistatic Coating Layer,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

An embodiment is directed to a polarizing film that includes a polarizer, a resin film as a base film, and an antistatic coating layer. The antistatic coating layer may contain a cured mixture of conductive polymer, a curable resin, a hydroxyacrylate compound, a cellulose compound, and a photopolymerization initiator.

The polarizing film including the antistatic coating layer may effectively prevent the generation of static electricity, and may have good adhesion to a triacetyl cellulose film as a resin base film and a pressure-sensitive adhesive (PSA) layer. The antistatic coating layer may be formed on a surface of a triacetyl cellulose film opposite to a surface to which a polyvinyl alcohol (PVA) film as a polarizer is bonded, i.e. formed on a same side of the triacetyl cellulose film as a pressure-sensitive adhesive.

The individual components used to form the antistatic coating layer will be explained below. A composition may be used for the formation of the antistatic coating layer (hereinafter, the composition is referred to simply as the ‘antistatic coating composition’).

Conductive Polymer

The conductive polymer is preferably water-soluble polyethylene dioxythiophene (PEDOT) as a thiophene polymer. More preferably, the conductive polymer is polyethylene dioxythiophene (PEDOT) having a molecular weight of about 150,000 to about 2,000,000 and doped with polystyrenesulfonate (PSS) as a dopant. Polyethylene dioxythiophene (PEDOT) tends to be soluble in water and is highly stable to heat, moisture and UV light. The term ‘PEDOT’ as used herein means one doped with PSS.

The PEDOT may be present in an amount of about 0.001 to about 20% by weight and preferably about 0.1 to about 10% by weight, based on the total weight of all components in the composition for the formation of the antistatic coating layer (hereinafter, referred to simply as the ‘antistatic coating composition’). The use of the PEDOT in an amount of less than about 0.001% by weight may undesirably increase the surface resistivity of the coating layer above 10¹⁴Ω/□, which corresponds to the lowest conductivity desirable for commercially available conductive thin films. The use of the PEDOT in an amount of more than about 20% by weight may make the coating layer sufficiently conductive, but may increase the thickness of the coating layer, resulting in poor optical properties in terms of luminance and color, may reduce the adhesion of the coating layer to a triacetyl cellulose base film, and may make it difficult to obtain a uniform thickness of the coating layer.

In the formation of the coating layer, the PEDOT may be added in the form of an aqueous solution. It is preferred to adjust the solid content of the PEDOT aqueous solution to about 1.2 to about 1.5% by weight in order to maintain the solubility of the PEDOT in water at an optimal level. For ease of coating, the PEDOT aqueous solution may be dispersed in high dielectric constant solvents such as water and/or alcohol, which are highly miscible with the PEDOT aqueous solution.

A representative example of the PEDOT dispersion is Baytron PH, Grade 500 (1.3 to 1.5 wt % aqueous solution), which is currently commercially available from H. C. Starck, Germany.

Curable Resin

As the curable resin, there may be used a resin having an acrylate group, for example, a (meth)acrylate resin of a polyester resin, a polyether resin, an acrylic resin, a urethane resin, an alkyd resin, a spiroacetal resin, a polybutadiene resin, a polythiolpolyene resin, or a polyfunctional compound (e.g., a polyhydric alcohol), which has a relatively low molecular weight.

Specific examples of curable resins suitable for use in the present invention include ethylene glycol diacrylate, neopentyl glycol di(meth)acrylate, 1,6-hexanediol (meth)acrylate, trimethylolpropane tri(meth)acrylate, dipentaerythritol hexa(meth)acrylate, polyol poly(meth)acrylate, di(meth)acrylate of bisphenol A-diglycidyl ether, polyester (meth)acrylate, which is obtainable by esterification of a polyhydric alcohol and a polyhydric carboxylic acid and/or an anhydride thereof and an acrylic acid, polysiloxane polyacrylate, urethane (meth)acrylate, pentaerythritol tetramethacrylate, and glycerine trimethacrylate. A fluorinated epoxy acrylate or a fluorinated alkoxysilane may also be used as the curable resin, and specific examples thereof include 2-(perfluorodecyl)ethyl methacrylate, 3-perfluorooctyl-2-hydroxypropyl acrylate, 3-(perfluoro-9-methyldecyl)-1,2-epoxypropane, 2,2,2-trifluoroethyl (meth)acrylate, 2,2,2-trifluoromethyl (meth)acrylate and 3,3,3,-trifluoropropyl (meth)acrylate. These compounds may be used alone or as a mixture of two or more thereof.

The curable resin is preferably present in an amount of about 1 to about 80% by weight, based on the total weight of the antistatic coating composition. If the content of the curable resin is less than about 1% by weight, the coating layer may crack. If the content of the curable resin exceeds about 80% by weight, there is a chance that the viscosity of the antistatic coating composition may increase.

Hydroxyacrylate Compound

The antistatic coating composition may include at least one hydroxyacrylate compound to improve the adhesive strength of the coating layer to the resin base film. Specific examples of the hydroxyacrylate compound include: oligomers, such as 2-hydroxyethyl acrylate oligomers, 2-hydroxypropyl acrylate oligomers, and pentaerythritol triacrylate oligomers; and monomers, such as 2-hydroxyethyl methacrylate, hydroxyethyl methacrylate, 2-hydroxypropyl methacrylate, 2-hydroxyethyl acrylate, 2-hydroxypropyl acrylate, Cardura acrylate, Cardura methacrylate, caprolactone acrylate, caprolactone methacrylate, 2,3-dihydroxypropyl acrylate, 2,3-dihydroxypropyl methacrylate, 4-hydroxymethylcyclohexyl methyl acrylate, and 4-hydroxymethylcyclohexyl methyl methacrylate.

The hydroxyacrylate compound may be present in an amount of about 1 to about 60% by weight, and preferably about 2 to about 15% by weight, based on the total weight of the antistatic coating composition. The use of the acrylate compound in an amount of less than about 1% by weight may reduce the curability of the antistatic coating composition, which may result in a reduction in the hardness of the coating layer, a non-uniform thickness of the coating layer, and poor adhesion of the coating layer to the resin base film. The use of the acrylate compound in an amount of more than about 60% by weight may increase the hardness of the coating layer, but may cause a change in the optical properties of the coating layer due to the increased thickness, and may increase the contact angle of the coating layer, resulting in low adhesive strength between the coating layer and the pressure-sensitive adhesive layer.

Cellulose Compound

The cellulose compound may be useful in forming a rigid coating on a film or a plastic support due to its good heat resistance and coatability. Specific examples of heat-resistant cellulose derivatives include esterification products of cellulose, such as cellulose acetate butyrate (CAB), cellulose acetate propionate (CAP), and cellulose acetate (CA). Such cellulose derivatives are easy to synthesize, and have the ability to form a coating on a film or a plastic support due to the presence of ester groups in the molecule.

Cellulose acetate butyrate (CAB), cellulose acetate propionate (CAP), or a mixture thereof is preferably used to improve the adhesive strength of the coating layer to the triacetyl cellulose film, and to improve the coatability and heat resistance of the antistatic coating composition.

The antistatic coating composition may be cured using UV light. The dissolution characteristics of cellulose acetate butyrate (CAB) in the UV-curable resin or at least one solvent of the antistatic coating composition may vary depending on the contents of acetyl and butyl groups in the structure of the CAB. The content of acetyl groups in the CAB may be between about 1 and about 80% by weight, and preferably between about 2 and about 30% by weight. The content of butyl groups in the CAB may be between about 10 and about 90% by weight, and preferably between about 20 and about 60% by weight.

The dissolution characteristics of cellulose acetate propionate (CAP) in the curable resin or at least one solvent of the antistatic coating composition may also vary depending on the contents of acetyl and propionyl groups in the structure of the CAP. The content of acetyl groups in the CAP may be between about 0.5 and about 5% by weight, and preferably between about 0.6 and about 3% by weight. The content of propionyl groups in the CAP may be between about 30 and about 60% by weight, and preferably between about 40 and about 50% by weight.

The cellulose compound may be present in an amount of about 0.1 to about 40% by weight, and preferably about 0.5 to about 15% by weight, based on the total weight of the antistatic coating composition. The use of the cellulose compound in an amount of less than about 0.1% by weight may deteriorate the adhesion of the coating layer to the base film and the heat resistance of the coating layer. The use of the cellulose compound in an amount of more than about 40% by weight may increase the viscosity of the coating layer, which may result in poor coatability of the composition and low hardness of the coating layer.

Photopolymerization Initiator

Suitable photopolymerization initiators may be used in antistatic coating composition, and specific examples thereof include acetophenones, benzophenones, such as 1-hydroxycyclohexylphenyl ketone, Michler's benzoylbenzoate, α-amyloxime ester, and thioxanthones.

The photopolymerization initiator is preferably used in an amount of about 0.1 to about 20% by weight, based on the total weight of the antistatic coating composition. If the content of the photopolymerization initiator is less than about 0.1% by weight, a curing reaction may not occur or a long reaction time may be needed, which may not be suitable for actual applications, and a sufficient hardness of the coating layer may not be obtained. If the content of the photopolymerization initiator exceeds about 20% by weight, a portion of the photopolymerization initiator may remain unreacted, which may result in a reduction in the hardness of the film.

Other Components

The antistatic coating layer may contain one or more additives, e.g., photosensitizers, polymerization inhibitors, leveling agents, wettability improvers, surfactants, plasticizers, UV absorbers, antioxidants, antistatic agents, silane coupling agents, inorganic fillers, defoaming agents, etc.

The antistatic coating composition may be prepared by the following procedure. In the description of the following procedure, references may be made to specific examples of materials for the antistatic coating composition. However, it will be appreciated that the procedure may be similarly used with other materials.

First, an alcohol and an ether as solvents may be sequentially added to a container having a predetermined volume, and an aqueous solution of PEDOT as the conductive polymer may be added thereto. The mixture may be vigorously stirred at room temperature for about 5 to about 30 minutes to prepare ‘Solution A’. Meanwhile, an alcohol and an ether as solvents may be sequentially added to a container having a predetermined volume, and the UV curable resin, the hydroxyacrylate compound, the cellulose compound (e.g., the cellulose acetate butyrate (CAB) or cellulose acetate propionate (CAP) resin), and the photopolymerization initiator may be added thereto. The mixture may be vigorously stirred at room temperature for about 5 to about 30 minutes to prepare ‘Solution B’. Solution A and Solution B may be mixed together in an appropriate ratio. The resulting mixture may be stirred for 30 minutes to 2 hours to prepare the final composition for the formation of the antistatic coating layer. Preferably, the composition may be passed through a filter (1.0 to 10 microns) to remove impurities contained therein. It is preferred to carry out the filtration under gravity in the absence of an external pressure, if possible.

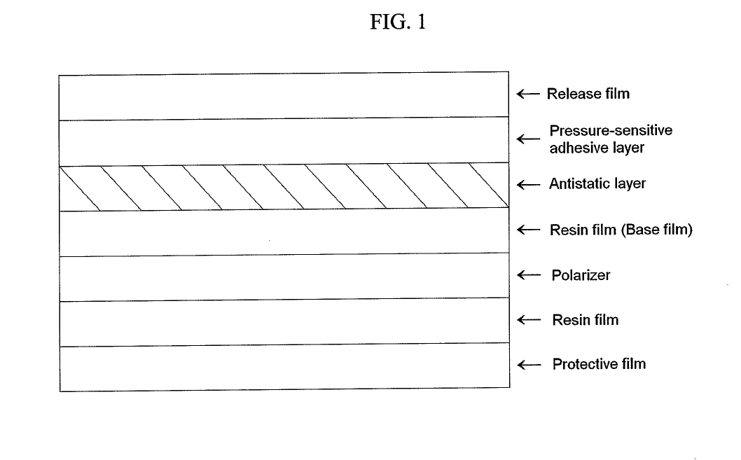

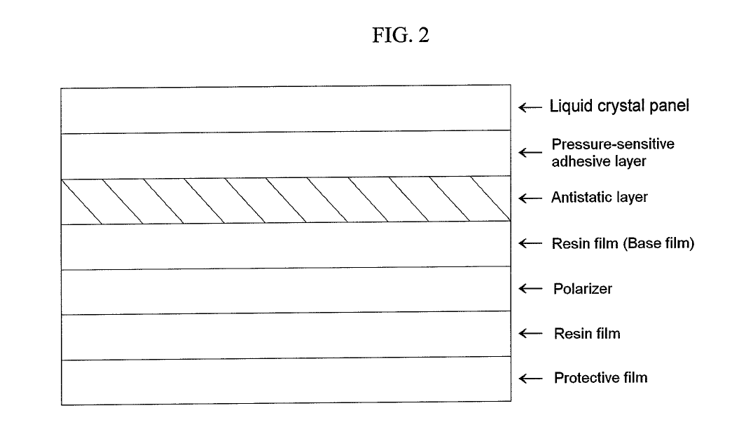

The antistatic coating composition may be coated on a surface of the resin base film opposite to a surface to which the polarizer is bonded, i.e. on a surface to which a pressure-sensitive adhesive is applied, to form the antistatic coating layer. FIG. 1 illustrates a schematic cross-sectional view of the polarizing film according to an embodiment. As shown in FIG. 1, a temporary release film may be attached to a surface of the polarizing film. FIG. 2 illustrates a schematic cross-sectional view of a liquid crystal display including polarizing film according to an embodiment. As shown in FIG. 2, the release film may be removed from the polarizing film, and the surface of the polarizing film exposed by the release film may be attached to a liquid crystal panel. A liquid crystal display according to an embodiment may include the liquid crystal panel and the polarizing film.

In the polarizing film, the resin base film, on which the antistatic coating composition is coated, may serve to protect/support the underlying polarizer. Suitable materials for the resin base film include cellulose ester, polyester, polycarbonate, norbornene, polyarylate, and polysulfone resins. Of these, triacetyl cellulose films, and biaxially stretched polyester and norbornene resin films, are more desirable in terms of transparency and durability. A triacetyl cellulose film is particularly preferred. A polycarbonate film is also preferably used in terms of durability and mechanical strength. The triacetyl cellulose film may be optionally saponified.

The polarizer may be a film that includes a polyvinyl alcohol resin and urea or a dichroic dye. Preparatory processes such as cleaning and drying may be performed to remove impurities from the polarizer. Preferably, a polyvinyl alcohol film is continuously stretched into the polarizer. Then, the polarizer is bonded to the resin base film.

A preferable thickness of the antistatic coating layer formed on the resin base film is about 50 nm to about 400 nm. If the coating layer is thinner than about 50 nm, the curability of the composition may be deteriorated, which may make it difficult to obtain a uniform thickness of the coating layer, and antistatic properties of the coating layer may not be satisfactory. If the coating layer is thicker than about 400 nm, excessive use of the composition may be uneconomical, the transparency of the coating layer may be impaired, and the contact angle of the coating layer may increase, which may result in low adhesive strength of the coating layer to the pressure-sensitive adhesive layer. Therefore, it is preferred to limit the thickness of the coating layer within the range defined above.

An example method for the formation of the antistatic coating layer will be explained below.

The antistatic coating composition may be applied to the resin base film by a suitable coating technique such as bar coating, knife coating, gravure coating, microgravure coating, or slot die coating. The composition may be dried to remove solvent, after which the coating may be cured, e.g., using irradiation with UV light in a UV curing system, to form the antistatic coating layer. The UV irradiation may be performed using a UV lamp such as a high-pressure mercury lamp, a metal halide lamp, a xenon lamp, or a microwave electrodeless lamp. The wavelength range and the exposure energy of UV light from the lamp to cure the coating may generally be from 300 to 400 nm and 100 to 1,000 mJ/m², respectively.

The antistatic coating composition may be coated on a surface of the resin base film opposite to a surface to which the polarizer is bonded, i.e. on a surface to which a pressure-sensitive adhesive is applied.

In a general polarizing film, high reliability and durability of a polarizing film under various environmental conditions are accomplished by strong adhesion between a polarizer and resin films constituting the polarizing film. For better adhesiveness, the surfaces of triacetyl cellulose films as the resin films may be previously saponified with an alkaline solution, and the polarizer may be adhered between the resin films by means of a suitable adhesive such as a polyvinyl alcohol adhesive. When an antistatic coating composition is coated on one of the surfaces of the base film to which the polarizer is bonded to form an antistatic coating layer, the adhesive strength of the antistatic coating layer to the polyvinyl alcohol adhesive should be taken into consideration. However, currently available adhesives fail to ensure sufficient adhesive strength to the antistatic coating layer. Weak adhesive strength between the antistatic coating layer and the adhesive may cause peeling of the polarizer from the resin film during rework testing or use of the polarizing film in LCD manufacturing processes. In contrast, embodiments may provide a polarizing film in which the antistatic coating composition is coated on the surface of the resin film at a same side as the pressure-sensitive adhesive.

The following Examples and Comparative Example are provided in order to set forth particular details of one or more embodiments. However, it will be understood that the embodiments are not limited to the particular details described. Further, the Comparative Example is set forth to highlight certain characteristics of certain embodiments, and is not to be construed as either limiting the scope of the invention as exemplified in the Examples or as necessarily being outside the scope of the invention in every respect.

### EXAMPLES

### Example 1

5 g of a dispersion of polyethylene dioxythiophene (Baytron PH, H. C. Starck) was dispersed in 40 g of a solution of ethanol and ethoxyethanol (1:1) for 10 minutes to prepare ‘Solution A’. 3.2 g of dipentaerythritol hexaacrylate (DPHA), 0.5 g of hydroxyethyl methacrylate (HEMA), 0.6 g of cellulose acetate butyrate and 0.7 g of Irgacure 184 (Ciba-Geigy) as a polymerization initiator were dispersed in 50 g of a solution of ethanol and ethoxyethanol (1:1) for 10 minutes to prepare ‘Solution B’.

Solution A was mixed with Solution B and stirred for 30 minutes to prepare an antistatic coating composition. A triacetyl cellulose film was saponified with a 15 wt % aqueous NaOH solution at 40° C. for 40 seconds, sufficiently cleaned, and dried. The composition was coated on the triacetyl cellulose film using a #4 bar coater, dried at 80° C. for 2 minutes, and cured by irradiation with UV light having an exposure energy of 500 mJ/cm² to form a film. The film was measured for surface resistivity, cross-cut, transmittance, haze, and contact angle in accordance with JIS standards. The results are shown in Table 1.

A rubbing test was conducted on the film using a clean room wiper (250 g, 5 reciprocations). An antistatically treated triacetyl cellulose film was used to produce a polarizing film, a pressure-sensitive adhesive (PSA) being applied thereto. A rework test of the polarizing film was conducted on bare LCD glass. The results are shown in Table 1.

Rework Test

After the antistatic composition was coated on one surface of a triacetyl cellulose film, a polarizer was laminated on the other surface of the triacetyl cellulose film to produce a polarizing film. Thereafter, an acrylic pressure-sensitive adhesive was applied to a thickness of about 25 μm, and a release film was laminated thereon. The laminate was aged under constant temperature (23±2° C.) and humidity (55±5%) conditions for about 7 days. The release film was removed from the laminate, and the resulting structure was attached to bare LCD glass under a constant load. The specimen was aged at 40° C. for about 72 hours and left standing at room temperature for one hour. After the film was peeled from the bare glass, the amount of the pressure-sensitive adhesive remaining on the glass was observed and the results were graded according to the following criteria:

Pass: no pressure-sensitive adhesive was left on the glass;

NG: a small portion of the pressure-sensitive adhesive was left on the glass.

### Example 2

The procedure of Example 1 was repeated except that cellulose acetate propionate (CAP) was used instead of the cellulose acetate butyrate (CAB).

### Comparative Example 1

The procedure of Example 1 was repeated except that 4.3 g of dipentaerythritol hexaacrylate (DPHA) was used, and hydroxyethyl methacrylate (HEMA) and cellulose acetate butyrate (CAB) were not used.

TABLE 1

| | | | Comparative |
|---|---|---|---|
| Properties | Example 1 | Example 2 | Example 1 |
| Surface resistivity (Ω/□) | 5 × 10⁸ | 8 × 10⁷ | 3 × 10⁹ |
| Cross-cut | 100/100 | 100/100 | 50/100 (NG) |
| Transmittance (%) | 92.56 | 92.65 | 92.32 |
| Haze (%) | 0.75 | 0.71 | 0.76 |
| Contact angle (°) | 54 | 45 | 32 |
| Rubbing test | Pass | Pass | NG |
| Rework test | Pass | Pass | NG |

As can be seen from the results in Table 1, in each of the polarizing films of Examples 1 and 2, the antistatic coating layer showed good adhesive strength to the resin base film and the pressure-sensitive adhesive (PSA) layer due to the presence of the hydroxyacrylate compound and the cellulose compound. In contrast, in the polarizing film of Comparative Example 1, the antistatic coating layer showed poor adhesive strength to the resin base film and the pressure-sensitive adhesive (PSA) layer.

In general, high reliability and durability of a polarizing film under various environmental conditions may be provided by strong adhesion between the polarizer and the resin films. The polarizer may be adhered between the resin films by means of a suitable adhesive such as a polyvinyl alcohol adhesive. For better adhesiveness, the surfaces of triacetyl cellulose films as the resin films may be prepared by subjecting them to saponification with an alkaline solution. However, saponification with an alkaline solution having a high concentration may be undesirable in terms of working safety and environmental protection. In addition, the alkaline treatment may make the surfaces of the resin films hydrophilic to significantly reduce the contact angle of the resin films. Further, the surface treatment of the resin films with a hydrophobic resin may bring about a reduction in the adhesive strength of the films. The surfaces of the resin films may be antistatically treated or hard-coated before saponification to impart functionality to the polarizing film. However, in this case, the surfaces of the resin films may be dissolved by the alkaline solution during saponification, and the antistatic or coating effects may be insignificant.

In addition, when a release film is removed from a general polarizing film to attach the polarizing film to the surface of an LCD through a pressure-sensitive adhesive layer, or when a protective film is peeled from the polarizing film, static electricity may be generated to damage the polarizing film. Further, impurities present between the constituent layers of the polarizing film may leave spots on the LCD screen, impede normal functioning of the LCD, or cause malfunction of the LCD during driving. Particularly, the generation of static electricity or the presence of impurities in any one of plural constituent layers of the LCD during driving may increase the risk of damage to the overall structure of the LCD.

Techniques to prevent the generation of static electricity in polarizing films may include the formation of a conductive layer on a triacetyl cellulose film, the use of a conductive pressure-sensitive adhesive or a conductive adhesive, and the formation of a conductive protective film. However, polarizing films based on such techniques may exhibit unsatisfactory optical properties (e.g., low transparency) and poor adhesiveness. Further, heat or moisture may adversely affect the performance of such polarizing films or cause foaming of such polarizing film, which is an impediment to practical use. Another technique may include applying a surfactant to a triacetyl cellulose film when a conductive layer is formed on the triacetyl cellulose film. However, such a technique may result in antistatic properties that are strongly dependent on humidity and are insufficient at low humidity.

In contrast, embodiments may provide a high-quality polarizing film that includes an antistatic coating layer having good adhesion to a saponified or unsaponified triacetyl cellulose film as a resin base film and a pressure-sensitive adhesive (PSA) layer, and having high transparency, low surface resistance, and high moisture resistance. The coating layer may be formed on a surface of the triacetyl cellulose film opposite to a surface to which a polyvinyl alcohol (PVA) film as a polarizer is bonded, to address various problems arising from the generation of static electricity when attached to an LCD or during driving of the LCD.

Furthermore, static electricity may not be generated in the polarizing film according to an embodiment when a release film attached to the PSA layer, which is formed by applying a pressure-sensitive adhesive to the antistatic coating layer, is removed to attach the polarizing film to an LCD, and when a protective film attached to the opposite triacetyl cellulose film, which is not antistatically treated, is removed from the polarizing film. Therefore, the polarizing film according to an embodiment may avoid problems associated with static electricity. For example, the polarizing film of the present invention may not leave spots on the LCD screen and may not cause a malfunction of the LCD during driving.

Example embodiments have been disclosed herein, and although specific terms are employed, they are used and are to be interpreted in a generic and descriptive sense only and not for purpose of limitation. Accordingly, it will be understood by those of skill in the art that various changes in form and details may be made without departing from the spirit and scope of the present invention as set forth in the following claims.

What is claimed is:

1. A polarizing film, comprising:
a polarizer;
a resin film as a base film; and
an antistatic coating layer, the antistatic coating layer containing a cured mixture of a conductive polymer, a curable resin, a hydroxyacrylate compound, a cellulose compound, and a photopolymerization initiator.

2. The polarizing film as claimed in claim 1, wherein the antistatic coating layer is formed by curing a composition that contains 0.001 to 20% by weight of the conductive polymer, 1 to 80% by weight of the curable resin, 1 to 60% by weight of the hydroxyacrylate compound, 0.1 to 40% by weight of the cellulose compound, and 0.1 to 20% by weight of the photopolymerization initiator.

3. The polarizing film as claimed in claim 1, wherein the conductive polymer is polyethylene dioxythiophene (PEDOT) doped with polystyrenesulfonate (PSS).

4. The polarizing film as claimed in claim 1, wherein the hydroxyacrylate compound includes one or more of an oligomer and a monomer.

5. The polarizing film as claimed in claim 4, wherein the hydroxyacrylate compound includes at least one oligomer, the at least one oligomer including one or more of 2-hydroxyethyl acrylate oligomer, 2-hydroxypropyl acrylate oligomer, and pentaerythritol triacrylate oligomer.

6. The polarizing film as claimed in claim 4, wherein the hydroxyacrylate compound includes at least one monomer, the at least one monomer including one or more of 2-hydroxyethyl methacrylate, hydroxyethyl methacrylate, 2-hydroxypropyl methacrylate, 2-hydroxyethyl acrylate, 2-hydroxypropyl acrylate, Cardura acrylate, Cardura methacrylate, caprolactone acrylate, caprolactone methacrylate, 2,3-dihydroxypropyl acrylate, 2,3-dihydroxypropyl methacrylate, 4-hydroxymethylcyclohexyl methyl acrylate, and 4-hydroxymethylcyclohexyl methyl methacrylate.

7. The polarizing film as claimed in claim 1, wherein the cellulose compound is cellulose acetate butyrate (CAB), cellulose acetate propionate (CAP), or a mixture thereof.

8. The polarizing film as claimed in claim 1, wherein the photopolymerization initiator includes one or more of an acetophenone, a benzophenone, Michler's benzoylbenzoate, α-amyloxime ester, a thioxanthone, or a mixture thereof.

9. The polarizing film as claimed in claim 1, wherein the antistatic coating layer is formed on a first surface of the resin film opposite to a second surface to which the polarizer is bonded, the second surface being a surface of the resin film to which a pressure-sensitive adhesive is applied.

10. The polarizing film as claimed in claim 1, wherein the antistatic coating layer has a thickness of about 50 nm to about 400 nm.

11. The polarizing film as claimed in claim 1, further comprising an acrylic pressure-sensitive adhesive layer, wherein:
the acrylic pressure-sensitive adhesive layer contacts the antistatic coating layer,
the antistatic coating layer contacts the resin film, the resin film being a triacetyl cellulose film, and
the cellulose compound is cellulose acetate butyrate (CAB), cellulose acetate propionate (CAP), or a mixture thereof.

12. A liquid crystal display, comprising:
a liquid crystal panel; and
a polarizing film, the polarizing film including an acrylate pressure-sensitive adhesive layer attaching the polarizing film to the liquid crystal panel, the polarizing film further including:
a polarizer;
a resin film as a base film; and
an antistatic coating layer contacting the acrylate pressure-sensitive adhesive layer and the resin film, the antistatic coating layer containing a cured mixture of a conductive polymer, a curable resin, a hydroxyacrylate compound, a cellulose compound, and a photopolymerization initiator.
